(19) United States
(12) Patent Application Publication
(10) Pub. No.: US 2011/0050865 A1
(43) Pub. Date: Mar. 3, 2011

(54) DISPLAY APPARATUS AND DRIVING METHOD THEREOF

(75) Inventors: Ki-bum SEONG, Anyang-si (KR); Jung-jin PARK, Seongnam-si (KR); Nak-won CHOI, Incheon (KR); Sang-un YUN, Seoul (KR); Jun-ho SUNG, Seoul (KR)

(73) Assignee: SAMSUNG ELECTRONICS CO., LTD., Suwon-si (KR)

(21) Appl. No.: 12/758,310

(22) Filed: Apr. 12, 2010

(30) Foreign Application Priority Data
Sep. 1, 2009 (KR) 10-2009-0082146

(51) Int. Cl. H04N 13/04

(52) U.S. Cl. 348/53; 348/56; 348/E13.075

(57) ABSTRACT

Disclosed are a display apparatus and a driving method thereof. The display apparatus includes: a video processor which processes an input video signal including a left-eye image and a right-eye image; a display unit which displays an image based on the video signal processed by the video processor; a backlight unit which emits light to the display unit; and a controller which controls at least one of the display unit and the backlight unit so that a margin period between a scan of the left-eye image and a scan of the right-eye image corresponds to a period during which the left shutter and the right shutter are shifted between opened and closed states.

### CROSS-REFERENCE TO RELATED PATENT APPLICATION

This application claims priority from Korean Patent Application No. 10-2009-0082146, filed on Sep. 1, 2009 in the Korean Intellectual Property Office, the disclosure of which is incorporated herein by reference.

### BACKGROUND OF THE INVENTION

1. Field of the Invention

Apparatuses and methods consistent with the present disclosure relate to a display apparatus and a driving method thereof, and a display apparatus, which can provide a clear image by preventing the brightness of a stereoscopic image from lowering, and a driving method thereof.

2. Description of the Related Art

A three-dimensional (3D) stereoscopic image displayed on a display apparatus such as a television (TV) or the like is generally based on binocular parallax that has the largest effect on giving a stereoscopic view at a short distance. Here, the 3D image can be seen through shutter-type 3D glasses, in which the left-eye image and the right-eye image are quickly alternated on a screen, and the shutter-type 3D glasses are opened and closed in sync with the left-eye image and the right-eye image to thereby achieve the 3D image. Specifically, the 3D glasses have an opened left-shutter and a closed right-shutter while the screen shows the left-eye image, but have the closed left-shutter and the opened right-shutter while the screen shows displays the right-eye image. Such shutter-type 3D glasses receive a synchronous signal in the form of an infrared (IR) signal.

Meanwhile, if the shutter-type 3D glasses employ liquid crystal, there is needed a response time that the liquid crystal operates in response to the synchronous signal. FIG. 1 shows a response time of the shutter-type 3D glasses using the liquid crystal. As shown in FIG. 1, an opening section of the left-eye shutter or the right-eye shutter includes an incomplete opening section b, b′ involving the response time, and a complete opening section a. A user can see the 3D image displayed on the screen during the opening sections a, b, b′. During the complete opening section a, a clear 3D image can be seen. However, during the incomplete opening sections b, b′, the left-eye shutter or the right-eye shutter is being opened or closed, and therefore the brightness of the 3D image is lowered.

### SUMMARY

Accordingly, an exemplary aspect provides a display apparatus and a driving method thereof, in which a data scanning time or a backlight scanning time is shortened to prevent the brightness of a 3D image from lowering during an incomplete opening period, thereby providing a clear stereoscopic image.

This and/or other exemplary aspects can be achieved by providing a display apparatus for a 3D image, the display apparatus including: a pair of glasses having a left shutter and a right shutter; a video processor which processes an input video signal including a left-eye image and a right-eye image; a display unit which displays an image based on the video signal processed by the video processor; a backlight unit which emits light to the display unit; and a controller which alternately controls at least one of the display unit and the backlight unit so that a margin period between a scan of the left-eye image and a scan of the right-eye image corresponds to a period during which the left shutter and the right shutter are shifted between opened and closed states.

The margin period may be equal in length to the period during which the left shutter and the right shutter are shifted between the opened and closed states.

The margin period may be generated by fixing a beginning point of the scan section and advancing a finishing point of the scan section.

The controller may control the backlight unit to sequentially scan a partial area of a screen in a scanning direction.

The display unit may include a liquid crystal display (LCD) panel, and the controller may control the LCD panel so that time for a data scan with respect to the LCD panel can correspond to the margin period.

The backlight unit may include a carbon nano tube (CNT).

The backlight unit may include an organic light emitting diode (OLED).

The scan of the left-eye image and the scan of the right-eye image may be data scans.

The scan of the left-eye image and the scan of the right-eye image may be backlight scans.

A scanning time for the backlight unit may be shorter than a scanning time for the display unit.

Another exemplary aspect may provide a display apparatus for a 3D image, the display apparatus including: a pair of glasses including a left shutter and a right shutter; a video processor which processes an input video signal including a left-eye image and a right-eye image; an organic light emitting diode (OLED) panel unit which displays an image based on the video signal processed by the video processor; and a controller which controls the OLED panel unit so that a margin period between a scan of the left-eye image and a scan of the right-eye image correspond to a period during which the left shutter and the right shutter are shifted between opened and closed states.

Still another exemplary aspect can provide a driving method of a display apparatus, using glasses comprising a left shutter and a right shutter which are alternately opened and closed corresponding to a left-eye image and a right-eye image for displaying a 3D image including: processing an input video signal including a left-eye image and a right-eye image for a 3D image; and controlling at least one of a data scanning time and a backlight scanning time such that a margin period between a scan of section between the left-eye image and a scan of the right-eye image corresponds to a period during which the left shutter and the right shutter are shifted between opened and closed states.

The margin period may be equal in length to the period during which the left shutter and the right shutter are shifted between the opened and closed states.

The margin period may be generated by fixing a beginning point of the scan section and advancing a finishing point of the scan section.

An image displayed on the screen may be displayed by scanning and displaying a partial area of the screen sequentially in a scanning direction.

The display apparatus may include a liquid crystal display (LCD) panel, and the controller controls the LCD panel so that time for a data scan with respect to the LCD panel can correspond to the margin period.

The backlight scanning time of the display apparatus may be shorter than the data scanning time.

A backlight scan may be achieved by a backlight unit employing a carbon nano tube (CNT).

A backlight scan may be achieved by a backlight unit employing an organic light emitting diode (OLED).

The scan of the left-eye image and the scan of the right-eye image may be data scans.

The scan of the left-eye image and the scan of the right-eye image may be backlight scans.

Yet another exemplary aspect provides a driving method of a display apparatus using glasses comprising a left shutter and a right shutter which are alternately opened and closed corresponding to a left-eye image and a right-eye image for displaying a 3D image and including an organic light emitting diode (OLED) panel, including: processing an input video signal including a left-eye image and a right-eye image for a 3D image; and generating a margin period between a data scan of the left-eye image and a data scan of the right-eye image corresponding to a period during which the left shutter and the right shutter are shifted between opened and closed states.

### BRIEF DESCRIPTION OF THE DRAWINGS

The above and/or other exemplary aspects will become apparent and more readily appreciated from the following description of exemplary embodiments, taken in conjunction with the accompanying drawings, in which:

FIG. 1 is a view illustrating a response time of shutter-type 3D glasses using a liquid crystal;

FIG. 2 is a view illustrating a configuration of a display apparatus according to an exemplary embodiment;

FIG. 3 is a view for explaining an exemplary operation of a display apparatus in FIG. 2;

FIG. 4 is a view for explaining another exemplary operation of a display apparatus in FIG. 2;

FIG. 5 is a view for explaining still another exemplary operation of a display apparatus in FIG. 2;

FIG. 6 is a view illustrating a configuration of a display apparatus according to another exemplary embodiment;

FIG. 7 is a view for explaining an exemplary operation of a display apparatus in FIG. 6;

FIG. 8 is a flowchart showing operation of a display apparatus according to an exemplary embodiment; and

FIG. 9 is a flowchart showing operation of a display apparatus according to another exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The present invention may be embodied in various forms without being limited to the embodiments set forth herein. Descriptions of well-known parts are omitted for clarity, and like reference numerals refer to like elements throughout.

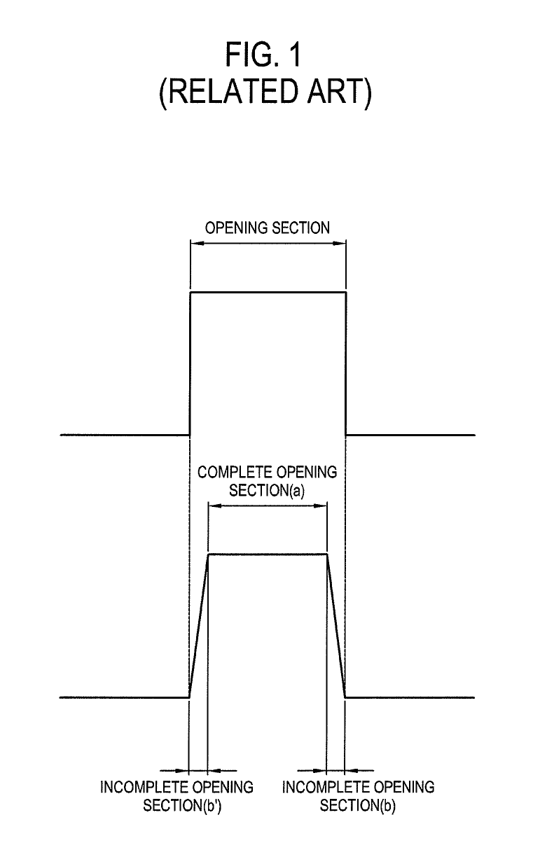

FIG. 1 is a view illustrating a response time of shutter-type 3D glasses using a liquid crystal;

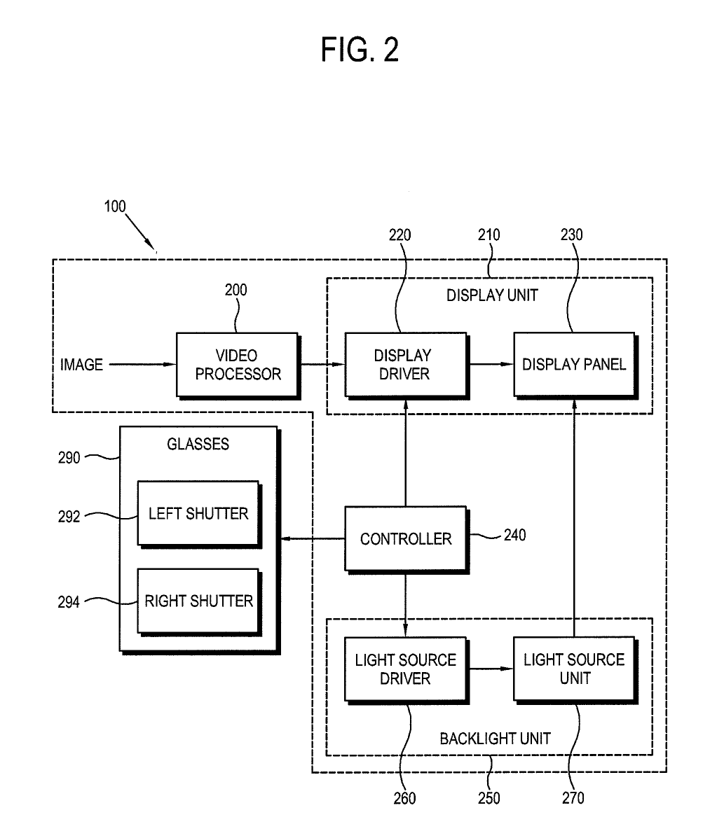

FIG. 2 is a view illustrating a configuration of a display apparatus according to an exemplary embodiment. As shown in FIG. 2, a display apparatus 100 in this exemplary embodiment includes a video processor 200, a display unit 210, a backlight unit 250, and a controller 240. The display unit 210 may include a display driver 220 and a display panel 230. The backlight unit 250 may include a light source driver 260 and a light source unit 270.

The video processor 200 processes an input 3D image containing a left-eye image and a right-eye image to be displayed on the display panel 230, and the display driver 220 drives the display panel 230 to display the 3D image processed by the video processor 200. The light source unit 270 of the backlight unit 250 emits light to the display panel 230, and the light source driver 260 drives the light source unit 270. The controller 240 controls the display driver 220 and the light source driver 260 to control a data scanning time and a backlight scanning time, and controls a left shutter 292 and a right shutter 294 of glasses 290 to be driven in sync with the left-eye image and the right-eye image displayed on the display panel 230. The 3D image displayed on the display apparatus 100 in this embodiment can be seen through the glasses 290, in which the glasses 290 comprise a shutter-type 3D glasses employing a liquid crystal, and include the left shutter 292 and the right shutter 294 which are opened and closed in sync with the left-eye image and the right-eye image displayed on the display panel 230.

The backlight unit 250 of the display apparatus 100 in this embodiment performs an impulsive operation. That is, if the input 3D image is processed in the video processor 200 and then the display driver 220 drives the display panel 230 to scan data, the light source unit 270 emits light according to partial areas of the display panel 230 so that the 3D image can be sequentially displayed on the display panel 230. The light source unit 270 is not being turned on as a whole, but a part thereof is being turned on and another part is being turned off. To drive the backlight unit 250 in this manner, the light source unit 270 may include a light emitting diode (LED), a carbon nano tube (CNT), an organic light emitting diode (OLED), or other light source as would be understood by one of skill in the art. The light source driver 260 is configured according to partial areas, and includes a plurality of multi-drivers so that each area can operate independently. If the backlight unit 250 performs the impulsive operation, an afterimage is prevented thereby providing an image improved in quality.

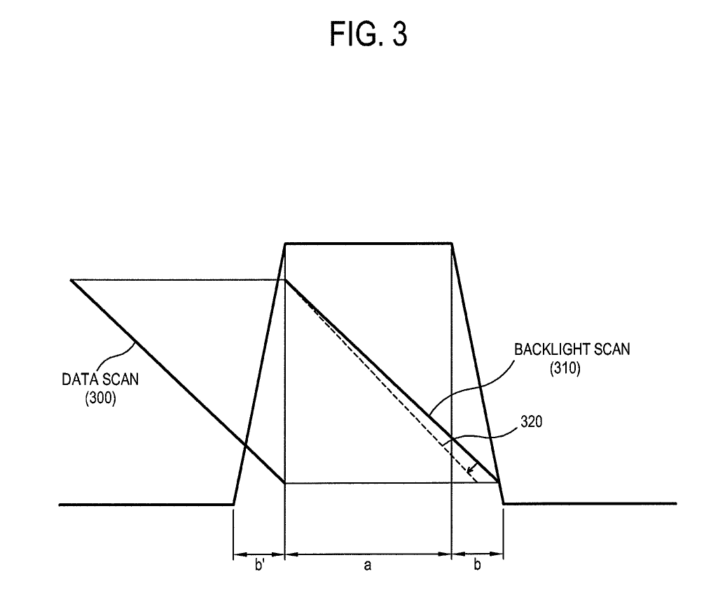

FIG. 3 is a view for explaining an exemplary operation of a display apparatus in FIG. 2. If the display apparatus 100 is driven at 120 Hz, one of plural frames constituting the input 3D image is displayed for 8.3 ms. Thus, the data scanning time for displaying one frame is 8.3 ms involving a discontinuing time in transmission, which is called a vertical blanking interval (VBI). When a data scan is completed, a backlight scan is performed, so that a user can see the 3D image displayed on the display panel 230 through the glasses 280. At this time, a user can see the 3D image displayed on the display panel 230 even in an incomplete opening section b, b′ where the left shutter 292 and the right shutter 294 are shifted. In the incomplete opening section b, b′, the brightness of the 3D image is lowered. As the time for allowing a user to see the 3D image displayed on the display panel 230 on the incomplete opening section b, b′ becomes shorter, a user can see a clearer displayed image. Thus, in the display apparatus 100 according to this embodiment, the controller 240 controls the light source driver 260 to shorten the time of backlight scan 310, 320 in order to shorten the time during which a user can see the 3D image in the incomplete opening section b, b′. As shown in FIG. 3, the display apparatus 100 in this embodiment finishes the backlight scan 310, 320 in the incomplete opening section b by shortens the backlight scanning time 310, 320 without changing the time of data scan 300. In FIG. 3, the solid line indicates the backlight scan 310 before shortening the scanning time, and the dotted line indicates the backlight scan 320 after shortening the scanning time. To this end, the controller 240 controls the light source driver 260 so that the backlight scan 310, 320 can begin in a completely opened state of the left shutter 292 or the right shutter 294 of the glasses 290 and finish in the incomplete opening section b.

For example, the data scan 300 for one of the plural frames constituting the 3D image is achieved for 8.3 ms while being driven at 120 Hz. On the other hand, the backlight scan 320 is scanned for a time shorter than 7.3 ms taken from the complete opening section a to the incomplete opening section b since the incomplete opening section is about 1 ms. Here, the backlight scan 320 for one frame involved in the 3D image begins in the complete opening section a. Further, the incomplete opening section b′ of before the complete opening section a starts is excluded since it corresponds to a section where a different frame is displayed earlier than the currently displayed frame. That is, the display apparatus 100 in this embodiment alternately displays the left-eye image and the right-eye image. Because the currently displayed frame starts undergoing the backlight scan 320 in the complete opening section a, if the frames for the left-eye image are currently displayed, the incomplete opening section b′ corresponds to a section where the frames for the right-eye image are displayed. In this case, a margin (interval) between a finishing point of the backlight scan for displaying the previously input frames and a beginning point of the backlight scan 320 for displaying the currently input frame, that is, between the backlight scanning sections for displaying the left-eye image and the right-eye image is generated in the incomplete opening section b where the left shutter 292 and the right shutter 294 of the glasses 290 are shifted between opened and closed states. The display apparatus 100 in this embodiment performs the backlight scan 320 in the incomplete opening section b, but the time for the backlight scan 320 is relatively short. To implement the backlight scan 320 in this manner, the controller 240 controls the light source driver 260 so that the backlight scan 320 can be performed more quickly as going from a top to a bottom of the display panel 230, thereby shortening the time for the backlight scan 320.

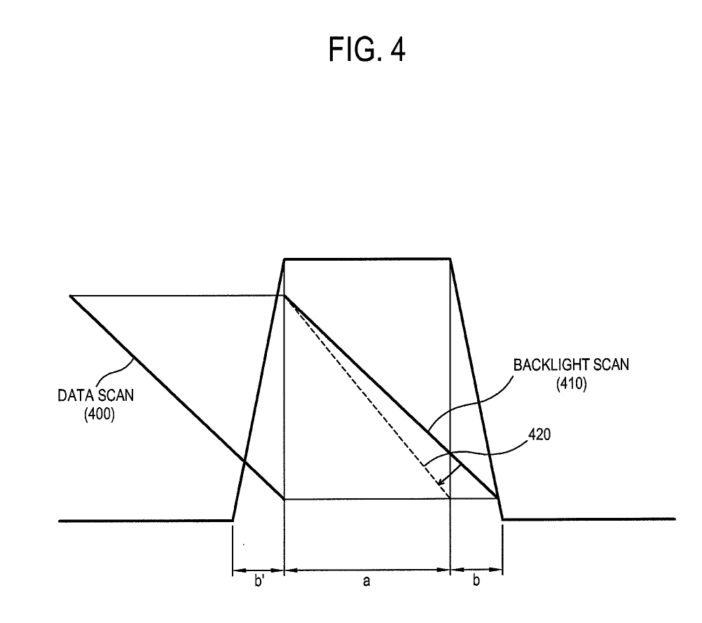

FIG. 4 is a view for explaining another exemplary operation of a display apparatus in FIG. 2. As shown in FIG. 4, only the time for the backlight scan 410, 420 is shorted without changing the time for the data scan 400. In FIG. 4, the solid line indicates the backlight scan 410 before shortening the scanning time, and the dotted line indicates the backlight scan 320 after shortening the scanning time. Since the brightness of an image is lowered in the incomplete opening section b where the left shutter 292 and the right shutter 294 of the glasses 280 are shifted, the backlight scan 420 is prevented in the incomplete opening section b. To this end, the controller 240 controls the light source driver 260 so that the backlight scan 420 can be performed only in the complete opening section a. In this case, the backlight unit 250 is driven for 6.3 ms corresponding to the complete opening section a while being driven at 120 Hz. In the display apparatus 100 according to this embodiment, the backlight scanning time is more shortened than that of the case where the backlight scan is partially performed in the incomplete opening section b. Thus, the backlight scan 420 is implemented only in the complete opening section a more rapidly than the case where the backlight scan 420 is implemented in the incomplete opening section b as going from the top to the bottom of the display panel 230. Like this, the display apparatus 100 in this embodiment performs the backlight scan 420 only in the complete opening section a, thereby preventing the brightness from lowering due to the backlight scan implemented in the incomplete opening section b and providing a clear 3D image. Further, a margin (interval) as much as the incomplete opening section b, i.e., as much as a section where the left shutter 292 and the right shutter 294 of the glasses 290 are shifted, is generated between the finishing point of the backlight scan 420 for displaying the previously input frames and the beginning point of the backlight scan for displaying the currently input frames.

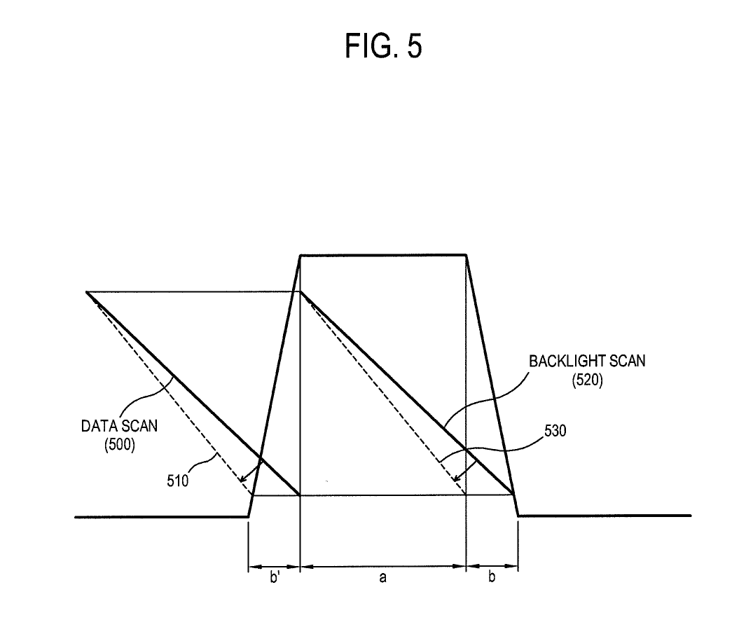

FIG. 5 is a view for explaining still another exemplary operation of a display apparatus in FIG. 2. As shown in FIG. 5, the display apparatus 100 in this embodiment shortens time for a backlight scan 520, 530 by shortening time for a data scan 500, 510. In FIG. 5, the solid line indicates the data scan 500 and the backlight scan 520 before shortening the scanning time, and the dotted line indicates the data scan 510 and the backlight scan 530 after shortening the scanning time. The controller 240 controls the light source driver 260 to implement the backlight scan 520, 530 leaving a certain time interval from a point of time when the data scan 500, 510 is generated so that the backlight scan 520, 530 corresponds to the data scan 500, 510. Thus, the time for the backlight scan 520, 530 can be shorted as the time for the data scan 500, 510 is shortened. For example, the controller 240 controls the display driver 220 to make the data scan 510 faster as going from the top to the bottom of the display panel 230, so that the backlight scan 530 can be partially performed in the incomplete opening section b or performed only in the complete opening section a. The light source driver 260 drives the light source unit 270 in accordance with the data scan 510, so that the time for the backlight scan 530 can be shortened as the time for the data scan 510 is shortened. Like this, the display apparatus 100 in this embodiment not only shortens the time for the backlight scan 530 but also prolongs a discontinuing time so called the VBI in the data transmission as the time for the data scan 510 is shortened. Accordingly, it is possible to sufficiently secure the response time of the glasses 290 in consideration of a response of a liquid crystal for the left shutter 292 and the right shutter 294 of the glasses 290, thereby providing a clear image.

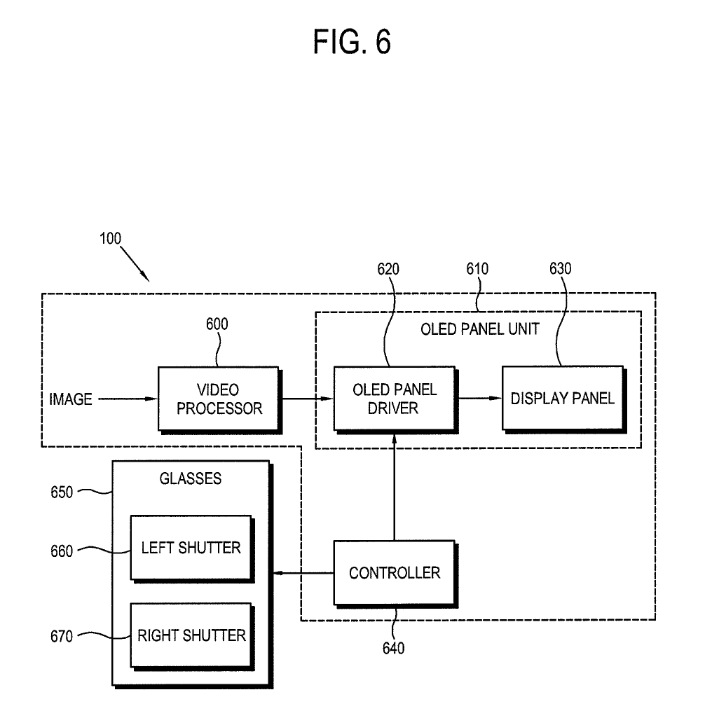

FIG. 6 is a view illustrating a configuration of a display apparatus according to another exemplary embodiment. As shown in FIG. 6, a display apparatus 100 in this embodiment includes a video processor 600, an OLED panel unit 610, and a controller 640. The OLED panel unit 610 may include an OLED panel driver 620 and a display panel 630. The video processor 600 processes an input 3D image involving a left-eye image and a right-eye image to be displayed on the display panel 630, and the OLED panel unit 610 drives the display panel 630 to display the 3D image processed by the video processor 600.

The controller 240 controls the OLED panel driver 620 to control the data scanning time, and controls the left shutter 660 and the right shutter 670 of the glasses 650 to be driven in sync with the left-eye image and the right-eye image displayed on the display panel 630.

The OLED refers to an organic material capable of emitting light by itself on the basis of an electroluminescent phenomenon that light is emitted when an electric current flows in an organic compound. Because such an OLED pixel emits light directly, an expressive range of light is greater than that of the LCD and there is no need of a backlight unit. Accordingly, it is possible to display the 3D image on the display panel 630 by implementing only the data scan with respect to the 3D image processed in the video processor 600, unlike a display apparatus using a general LCD panel.

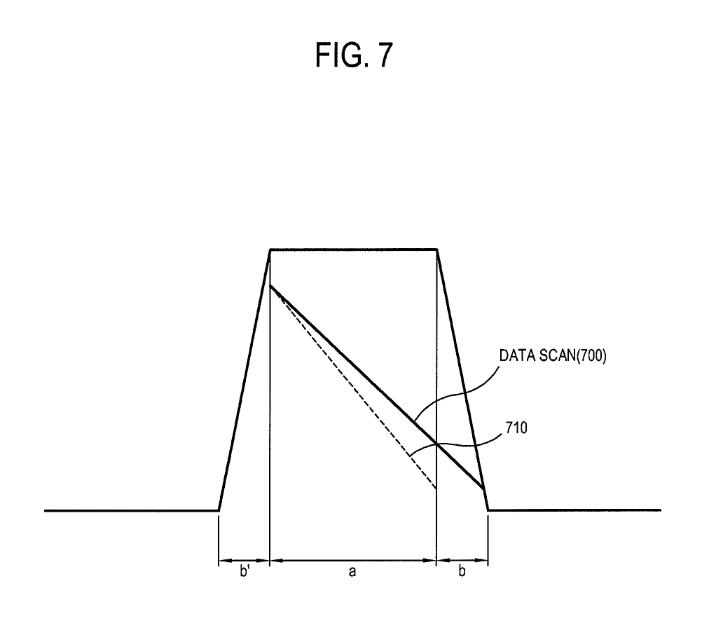

FIG. 7 is a view for explaining an exemplary operation of a display apparatus in FIG. 6. As shown in FIG. 7, the time for the data scan 700, 710 is shortened so as not to perform the data scan in the incomplete opening section b where the brightness of an image is lowered. Here, the solid line indicates the data scan 700 before shortening the scanning time, and the dotted line indicates the data scan 710 after shortening the scanning time. To this end, the controller 640 controls the OLED panel driver 620 to perform the data scan 710 only in the complete opening section a.

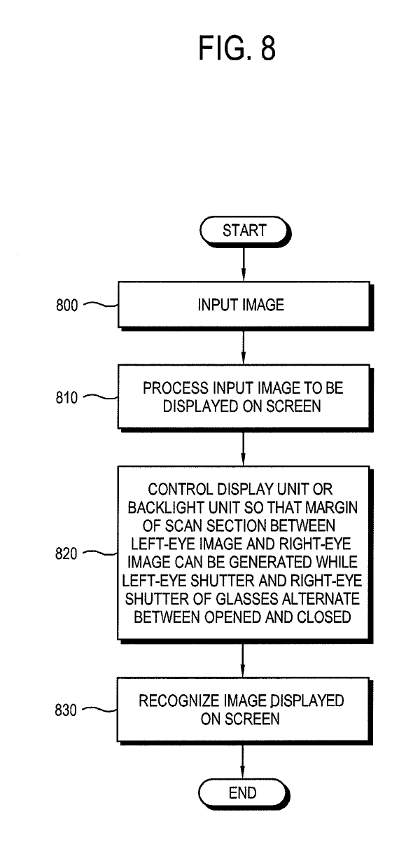

FIG. 8 is a flowchart showing operation of a display apparatus according to an exemplary embodiment. As shown in FIG. 8, when a 3D image involving a left-eye image and a right-eye image is input at operation 800, the video processor 200 processes the input image to be displayed on the display panel 230 at operation 810. Then, the left shutter 292 and the right shutter 294 are provided to be alternately opened and closed corresponding to the left-eye image and the right-eye image, and the controller 240 controls the display unit 210 or the backlight unit 250 so that a margin (interval) of a scan section between the left-eye image and the right-eye image can be generated while the left shutter 292 and the right shutter 294 of the glasses 290 for allowing a user to see the image displayed on the display panel 230 are shifted between the opened and closed states at operation 820. That is, the controller 240 controls the light source driver 260 to shorten the backlight scanning time or the display driver 220 to shorten the data scanning time, and also controls the light source driver 260 to make the backlight scan correspond to the data scan, thereby shortening the backlight scanning time. Then, if the display panel 230 displays an image, a user can see the displayed image through the glasses 290 at operation 830.

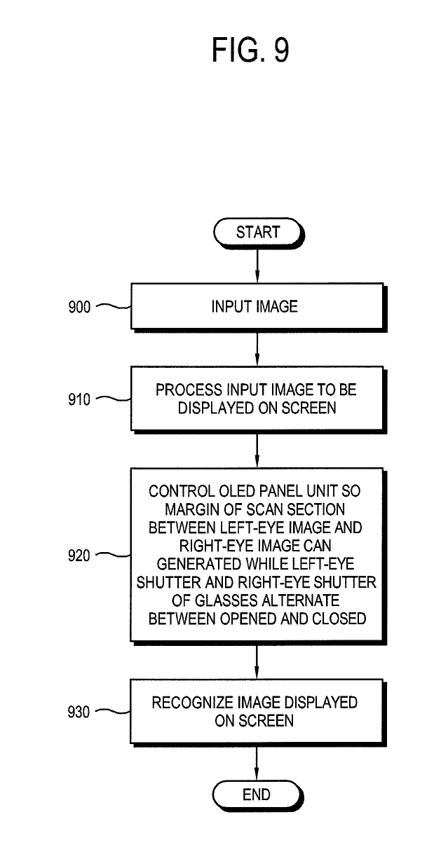

FIG. 9 is a flowchart showing operation of a display apparatus according to another exemplary embodiment. As shown in FIG. 9, when a 3D image involving a left-eye image and a right-eye image is input at operation 900, the video processor 600 processes the input image to be displayed on the display panel 630 at operation 910. Then, the left shutter 660 and the right shutter 670 are provided to be alternately opened and closed corresponding to the left-eye image and the right-eye image, and the controller 640 controls the OLED panel driver 620 so that a margin (interval) of a scan section between the left-eye image and the right-eye image can be generated while the left shutter 660 and the right shutter 670 of the glasses 650 for allowing a user to see the image displayed on the display panel 630 are shifted between the opened and closed states at operation 920. That is, the controller 640 controls the OLED panel driver 620 to shorten the data scanning time. Then, if the display panel 630 displays an image, a user can see the displayed image through the glasses 650 at operation 930.

As described above, the brightness of the 3D image is prevented from lowering to thereby provide a clear image.

Also, the data scanning time is shortened so that the response time of the 3D glasses can be sufficiently secured according to the response of the liquid crystal.

Although a few exemplary embodiments have been shown and described, it will be appreciated by those skilled in the art that changes may be made in these embodiments without departing from the principles and spirit of the invention, the scope of which is defined in the appended claims and their equivalents.

What is claimed is:

1. A display apparatus using glasses comprising a left shutter and a right shutter which are alternately opened and closed corresponding to a left-eye image and a right-eye image for displaying a 3D image, the display apparatus comprising:
a video processor which processes an input video signal comprising a left-eye image and a right-eye image;
a display unit which displays an image based on the video signal processed by the video processor;
a backlight unit which emits light to the display unit; and
a controller which alternately controls at least one of the display unit and the backlight unit so that a margin period between a scan of the left-eye image and a scan of the right-eye image corresponds to a period during which the left shutter and the right shutter are shifted between opened and closed states.

2. The display apparatus according to claim 1, wherein the margin period is equal in length to the period during which the left shutter and the right shutter are shifted between the opened and closed states.

3. The display apparatus according to claim 1, wherein the margin period is generated by fixing a beginning point of the scan section and advancing a finishing point of the scan section.

4. The display apparatus according to claim 1, wherein the controller controls the backlight unit to sequentially scan a partial area of a screen in a scanning direction.

5. The display apparatus according to claim 1, wherein the display unit comprises a liquid crystal display (LCD) panel, and the controller controls the LCD panel so that time for a data scan with respect to the LCD panel can correspond to the margin period.

6. The display apparatus according to claim 1, wherein the backlight unit comprises a carbon nano tube.

7. The display apparatus according to claim 1, wherein the backlight unit comprises an organic light emitting diode.

8. The display apparatus according to claim 1, wherein the scan of the left-eye image and the scan of the right-eye image are data scans.

9. The display apparatus according to claim 1, wherein the scan of the left-eye image and the scan of the right-eye image are backlight scans.

10. The display apparatus according to claim 1, wherein a scanning time for the backlight unit is shorter than a scanning time for the display unit.

11. A display apparatus using glasses comprising a left shutter and a right shutter which are alternately opened and closed corresponding to a left-eye image and a right-eye image for displaying a 3D image, the display apparatus comprising:
a video processor which processes an input video signal comprising a left-eye image a the right-eye image;
an organic light emitting diode (OLED) panel unit which displays an image based on the video signal processed by the video processor; and
a controller which controls the OLED panel unit so that a margin period between a scan of the left-eye image and a scan of the right-eye image corresponds to a period during which the left shutter and the right shutter are shifted between opened and closed states.

12. A driving method of a display apparatus using glasses comprising a left shutter and a right shutter which are alternately opened and closed corresponding to a left-eye image and a right-eye image for displaying a 3D image, comprising:
processing an input video signal comprising a left-eye image and a right-eye image for a 3D image;
and
controlling at least one of a data scanning time and a backlight scanning time such that a margin period between a scan of the left-eye image and a scan of the right-eye image corresponds to a period during which the left shutter and the right shutter are shifted between opened and closed states.

13. The driving method according to claim 12, wherein the margin period is equal in length to the period during which the left shutter and the right shutter are shifted between the opened and closed states.

14. The driving method according to claim 12, wherein the margin period is generated by fixing a beginning point of the scan section and advancing a finishing point of the scan section.

15. The driving method according to claim 12, further comprising displaying an image on a screen by scanning and displaying a partial area of the screen sequentially in a scanning direction.

16. The driving method according to claim 12, wherein the display apparatus comprises a liquid crystal display (LCD) panel, and the controller controls the LCD panel so that time for a data scan with respect to the LCD panel can correspond to the margin period.

17. The driving method according to claim 12, wherein a backlight scanning time of the display apparatus is shorter than a data scanning time.

18. The driving method according to claim 12, further comprising backlighting the display apparatus with a backlight unit comprising a carbon nano tube.

19. The driving method according to claim 12, further comprising backlighting the display apparatus with a backlight unit comprising an organic light emitting diode.

20. The driving method according to claim 12, wherein the scan of the left-eye image and the scan of the right-eye image are data scans.

21. The driving method according to claim 12, wherein the scan of the left-eye image and the scan of the right-eye image are backlight scans.

22. A driving method of a display apparatus using glasses comprising a left shutter and a right shutter which are alternately opened and closed corresponding to a left-eye image and a right-eye image for displaying a 3D image and comprising an organic light emitting diode (OLED) panel, the method comprising:
processing an input video signal comprising a left-eye image and a right-eye image for a 3D image;
and
generating a margin period between a data scan of the left-eye image and a data scan of the right-eye image corresponding to a period during which the left shutter and the right shutter are shifted between opened and closed states.
